(19) United States
(12) Patent Application Publication
(10) Pub. No.: US 2024/0399346 A1
(43) Pub. Date: Dec. 5, 2024

(54) SINGLE-ATOM CATALYST WITH MOLECULAR SIEVE-CONFINED DOMAINS, PREPARATION METHOD AND APPLICATION THEREOF

(71) Applicant: Institute of Process Engineering, Chinese Academy of Sciences, Beijing (CN)

(72) Inventors: Tingyu ZHU, Beijing (CN); Wenqing XU, Beijing (CN); Huixian LIU, Beijing (CN); Yixi WANG, Beijing (CN); Chaoqun LI, Beijing (CN)

(21) Appl. No.: 18/661,213

(22) Filed: May 10, 2024

(30) Foreign Application Priority Data
Jun. 1, 2023 (CN) 202310642788.5

(51) Int. Cl. B01J 29/48; B01D 53/86; B01J 35/30; B01J 37/00; B01J 37/02; B01J 37/03; B01J 37/04; B01J 37/06

(52) U.S. Cl. CPC B01J 29/48; B01D 53/8628; B01J 35/394; B01J 37/0018; B01J 37/0209; B01J 37/0236; B01J 37/035; B01J 37/04; B01J 37/06; B01D 2255/1028; B01D 2255/20776; B01D 2257/404; B01D 2258/0283; B01J 2229/183

(57) ABSTRACT

A single-atom catalyst with molecular sieve-confined domains and a preparation method and application thereof are provided in the present disclosure. According to the present disclosure, the physical structure and chemical anchoring action of the molecular sieve are utilized to confine the bimetallic ions, so that the bimetallic ions of the catalyst are dispersed in single atoms, electrons in the bimetallic ions are transferred from transition metals to precious metals to promote d-π* orbital hybridization to enhance NO adsorption, and an electron-rich environment and sufficient active sites are provided for NO adsorption and dissociation in the CO-SCR reaction; the transition metals adsorb CO to promote the transformation of N₂O, NO₂ and other intermediates into N₂, and the transition metal serves as a sacrificial site for the poisoning of SO₂ to enhance the sulphur-resistant property of the catalyst.

### CROSS-REFERENCE TO RELATED APPLICATIONS

This application claims priority to Chinese Patent Application No. 202310642788.5, filed on Jun. 1, 2023, the contents of which are hereby incorporated by reference.

### TECHNICAL FIELD

The present application belongs to the technical fields of environmental catalysis, air pollution control and flue gas denitrification catalysis, and in particular to a single-atom catalyst with molecular sieve-confined domains, and a preparation method and application thereof.

### BACKGROUND

NO is a major air pollutant produced by fuel combustion in stationary and mobile sources. In recent years, NO emissions have caused various environmental problems such as acid rain, photochemical smog, ozone depletion and haze, as well as greenhouse gas emissions. Currently, Selective catalytic reduction with NH₃ (NH₃-SCR) is widely used for NO removal, but problems exist such as the high toxicity and corrosiveness of NH₃, the reaction of NH₃ with H₂O and SO₃ to develop ammonium sulphate, and the consumption of large amounts of fossil fuels for the synthesis of NH₃.

In many catalytic reactions, it has been found that when the particle size of the active component is reduced to dispersed loading in the form of single atoms, the unique electronic structure and homogeneous active sites may substantially improve the reaction activity and product selectivity. The catalytic materials of metal with molecular sieve-confined domains give full play to the synergistic effect of metal and molecular sieve carriers to achieve the flexible regulation of the reaction microenvironment, and exhibit a wide range of applicability and excellent catalytic performance in several reactions. The synthesis of catalysts designed on the atomic scale enables a green and economical synthesis process by improving metal utilization and effectively reduces the use of metal resources, especially the cost of precious metal catalysts. However, under conventional impregnation conditions, single atoms and nanoparticles usually coexist, with nanoparticles usually having poor catalytic activity, moreover, although CO in the flue gas is used for CO-SCR and simultaneous removal of CO and NO is possible, yet CO-SCR usually has problems of low oxygen resistance, and although precious metals are the active components suitable for higher oxygen content, they usually have the problems of poor stability, low catalytic activity and poor sulphur resistance.

Therefore, it is an urgent problem for the skilled person of the art to provide a molecular sieve domain-limited single-atom catalyst and a preparation method and application thereof, so as to enhance the oxygen resistance, catalytic activity, sulphur resistance and stability of the single-atom catalyst.

### SUMMARY

In order to solve the above technical problems, the present disclosure provides a single-atom catalyst with molecular sieve-confined domains, and a preparation method and application thereof, whereby bimetallic ions are confined in a physical structure of a molecular sieve by a post-processing method or an in-situ synthesis method, the bimetallic ions are uniformly dispersed in the physical structure of the molecular sieve, and oxygen vacancies on surfaces of the precious metals and transition metals are jointly used as adsorption sites for NO, so that the catalysts show excellent catalytic activity and stability under low precious metal loading, and thus the CO-SCR reaction in oxygen-containing atmospheres achieves high denitrification efficiency and high N₂ selectivity.

In order to achieve the above objectives, the present disclosure adopts the following technical scheme.

An aspect of the present disclosure provides a single-atom catalyst with molecular sieve-confined domains, where the single-atom catalyst takes a molecular sieve as a carrier and bimetallic ions as active components, and the bimetallic ions are confined in a physical structure of the molecular sieve by utilizing the physical structure and a chemical anchoring action of the molecular sieve.

The above scheme has the beneficial effects that the bimetallic ions are confined into monatomic states by using the cage or pore structure of the molecular sieve carrier, so that an electron-rich interface environment and sufficient active sites may be provided for the adsorption and dissociation of NO; meanwhile, there is a synergistic effect among the bimetallic ions, the molecular sieve carrier and bimetallic ions, so that the catalytic reaction activity and ideal product selectivity of the catalyst may be improved; and the obtained catalyst has excellent sulfur resistance, water resistance and stability, boasting a broad application prospect.

Optionally, the physical structure of the molecular sieve includes a cage or a pore structure; and the chemical anchoring action is carried out by using aluminum-rich sites of molecular sieves; and
the beneficial effects are: the physical structure of the molecular sieve is exploited to achieve single-atom dispersion by confining the active metal domains in different cages or pore structures, while the single atoms are anchored using aluminum-rich sites, thereby improving the stability of the single-atom catalyst in a CO-SCR atmosphere.

Optionally, the molecular sieve includes one or more of type A molecular sieve with SOD and/or LTA cage structure, type X molecular sieve with super cage and/or SOD cage structure, type Y molecular sieve with super cage and/or SOD cage structure, MCM molecular sieve with super cage and cross pore structure, SAPO molecular sieve with CHA cage and cross pore structure, and ZSM molecular sieve with cross pore structure.

Optionally, the type A molecular sieve includes a 3A molecular sieve, a 4A molecular sieve and a 5A molecular sieve; the X-type molecular sieve includes a 10× molecular sieve and a 13× molecular sieve; the type Y molecular sieve includes a HY molecular sieve, a NaY molecular sieve and a USY molecular sieve; the MCM molecular sieve includes an MCM-22 molecular sieve, an MCM-41 molecular sieve and an MCM-48 molecular sieve; the SAPO molecular sieve includes an SAPO-5 molecular sieve, an SAPO-11 molecular sieve, an SAPO-34 molecular sieve, an SAPO-44 molecular sieve and an SAPO-47 molecular sieve; the ZSM molecular sieve includes a ZSM-5 molecular sieve, a ZSM-11 molecular sieve, a ZSM-12 molecular sieve, a ZSM-35 molecular sieve and a ZSM-48 molecular sieve.

Optionally, a diameter of the cage or pore structure is larger than a diameter of a reaction gas.

Optionally, the diameter of the cage or pore structure is ≥4 Å, and specifically, it is 4 Å-13 Å.

More optionally, the diameter of the cage or pore structure includes 4 Å, 5 Å, 6 Å, 7 Å, 8 Å, 9 Å, 10 Å, 11 Å, 12 Å or 13 Å.

Optionally, the reaction gas includes NO, CO, O₂ and N₂.

Optionally, the bimetallic ions are a combination of precious metal ions and transition metal ions.

Optionally, a loading of the precious metal ions in the single-atom catalyst is 0.1%-1%.

Optionally, a loading of the transition metal ions in the single-atom catalyst is 0.1%-10%.

Optionally, the loading is a mass fraction.

Optionally, an electronegativity of the precious metal ions is greater than that of the transition metal ions.

Optionally, an electronegativity value of the precious metal ions is 1-15.6; and an electronegativity value of the transition metal ion is 1-15.3.

Optionally, an electronegativity difference between the precious metal ions and the transition metal ions is 0.1-3, more specifically, 0.5-0.95.

Optionally, the precious metal ions include one of Ir ions, Ag ions, Pt ions, Rh ions, Pd ions, Ru ions or Au ions.

Optionally, the transition metal ions include one of W ions, Mo ions, Ce ions, Co ions, Mn ions or Cu ions.

The beneficial effects of the above preferred and optional schemes are: according to the present disclosure, the single-atom catalyst enhances NO adsorption through electron transfer between bimetallic ions and promotes d-π* orbital hybridization to improve the competitive adsorption of O₂ and NO, thereby improving the catalyst's oxygen resistance and increasing the catalyst's NO conversion in CO-SCR; the adsorption of CO by transition metals promotes the transformation of N₂O, NO₂ and other intermediates into N₂, which improves the N₂ selectivity of the catalyst. At the same time, transition metals as sacrificial sites improve the sulfur resistance of the catalyst.

It is to be noted that the surface of the single-atom catalyst with molecular sieve-confined domains designed in this disclosure has rich acid sites, in which the bridging hydroxyl group (Si—OH—Al) acts as the Brønsted (B) acid site. Metal ions coordinate with O of the B acid site to achieve anchoring on the molecular sieve carrier. Meanwhile, the acidic sites are tightly coupled with metal ions with a synergistic effect, capable of increasing the selectivity (up to 90%) of the desired products for the catalytic reduction of NO by CO, in which the content of B acid sites in the acidic sites is higher than 50%.

In another aspect, the present disclosure provides a preparation method of the single-atom catalyst with molecular sieve-confined domains, and the preparation method includes a post-processing method or an in-situ synthesis method; and
the post-processing method includes the following steps:
S1, mixing a template agent, a silicon source, an aluminum source, alkali and water according to a molar ratio of a general formula of a molecular sieve, heating in a hydrothermal kettle for hydrothermal reaction, collecting and separating out molecular sieve crystals, drying and roasting to obtain the molecular sieve; and
S2, mixing precursors of the molecular sieve and bimetallic ions with a solvent for a reaction, carrying out solid-liquid separation on a reaction product, collecting and drying a solid, and activating the solid after drying to obtain the single-atom catalyst with molecular sieve- confined domains.

The in-situ synthesis method includes the following steps: mixing a template agent, a silicon source, an aluminum source, an alkali and water according to a molar ratio of the general formula of the molecular sieve, simultaneously adding precursors of bimetallic ions and ligands, and heating in a hydrothermal kettle for a hydrothermal reaction, performing centrifugal washing and drying on precipitated molecular sieve crystals loaded with bimetallic metals, and then roasting to obtain the single-atom catalyst with molecular sieve-confined domains.

Optionally, the general formula of the molecular sieve in the post-processing method and the in-situ synthesis method is (M′2M)O·Al₂O₃·xSiO₂·yH₂O.

Optionally, in the general formula of the molecular sieve, x is a ratio of silicon to aluminum, with a value of 2-500.

Optionally, a value of y in the general formula of the molecular sieve is 50-250.

Optionally, in the post-processing method and the in-situ synthesis method:
the template agent includes one of tetramethylammonium hydroxide, tetrapropylammonium hydroxide, tetrapropylammonium bromide, tetraethylammonium bromide and cetyltrimethylammonium bromide;
the silicon source includes one of water glass, silica sol, silica gel, amorphous SiO₂ powder and Si(OCH₃)₄, Si(OC₂H₅)₄;
the aluminum source includes one of sodium metaaluminate, boehmite, pseudo-boehmite, amorphous aluminum hydroxide powder and aluminum isopropoxide;
the alkali includes one of sodium hydroxide and potassium hydroxide; and
the precursors of bimetallic ions include precursors of precious metal ions and precursors of transition metal ions.

Optionally, a pH of the template, silicon source, aluminum source, alkali and water after mixing is 10-14, optionally including but not limited to pH 10, pH 11, pH 12, pH 13 or pH 14.

Optionally, the precursors of the precious metal ions include iridium acetate and/or chloroiridium acid, silver nitrate and/or silver chloride, chloroplatinic acid and/or platinum tetraamine dinitrate, rhodium acetate and/or rhodium trichloride, palladium nitrate and/or chloroplatinic acid, ruthenium acetate and/or ruthenium chloride, gold acetate and/or chloroauric acid.

Optionally, the precursors of the transition metal ions include ammonium metatungstate and/or ammonium tungstate, ammonium molybdate, cerium nitrate, cobalt nitrate, manganese nitrate and copper nitrate.

Optionally, the precursors of the precious metal ion are configured as a solution for use with a solution concentration of 1-10 grams per liter (g/L), optionally including but not limited to 1 g/L, 2 g/L, 3 g/L, 4 g/L, 5 g/L, 6 g/L, 7 g/L, 8 g/L, 9 g/L or 10 g/L; and
the precursors of the transition metal ions are configured as a solution for use with a solution concentration of 1-10 g/L, optionally including but not limited to 1 g/L, 2 g/L, 3 g/L, 4 g/L, 5 g/L, 6 g/L, 7 g/L, 8 g/L, 9 g/L or 10 g/L.

Optionally, in step S1 of the post-processing method:
a temperature of the hydrothermal reaction is 80-200 degrees Celsius (C), optionally including but not limited to 80° C., 100° C., 120° C., 140° C., 160° C., 180° C. and 200° C.;
a duration of the hydrothermal reaction is 24-120 hours (h), optionally including but not limited to 24 h, 48 h, 60 h, 72 h, 84 h, 96 h, 108 h or 120 h;
a temperature for the drying is 80-120° C., optionally including but not limited to 80° C., 90° C., 100° C., 110° C. or 120° C.;
a duration of the drying is 4-24 h, optionally including but not limited to 4 h, 8 h, 12 h, 16 h, 20 h or 24 h;
a temperature of the roasting is 400-800° C., and a heating rate is 1-10 degrees Celsius per minute (° C./min), optionally including but not limited to 1° C./min, 5° C./min or 10° C./min; and
a duration of the roasting is 8-24 h, optionally including but not limited to 8 h, 12 h, 16 h, 20 h or 24 h.

Optionally, in step S2 of the post-processing method:
the solvent is water;
a temperature of the reaction is 25-100° C., optionally including but not limited to 25° C., 26° C., 27° C., 28° C., 29° C., 30° C., 35° C., 40° C., 50° C., 60° C., 70° C., 80° C. or 100° C.; more specifically, the temperature of the reaction is 50° C.;
a duration of the reaction is 1-6 h, optionally including but not limited to 1 h, 2 h, 3 h, 4 h, 5 h or 6 h, and more specifically, the duration of the reaction is 4 h;
a pH value of the reaction is 6-8, optionally including but not limited to pH 6, pH 7 or pH 8, and more specifically pH 8;
a method of the solid-liquid separation includes filtration, rotary steaming and/or centrifugation;
a method of the drying includes one or a combination of vacuum drying or air atmosphere drying;
a temperature of the drying is 100-120° C., optionally including but not limited to 100° C., 101° C., 102° C., 103° C., 108° C., 110° C., 115° C., 117° C., 118° C., 119° C. or 120° C.;
a method of the activating includes any one or a combination of at least two of vacuum activation, air atmosphere activation, inert atmosphere activation or reducing atmosphere activation; and
a temperature of the activating is 350-600° C., optionally including but not limited to 350° C., 360° C., 380° C., 400° C., 420° C., 460° C., 500° C., 540° C., 560° C., 580° C. or 600° C.; a heating rate is 2-10° C./min, optionally including but not limited to 2° C./min, 3° C./min, 4° C./min, 5° C./min, 6° C./min, 7° C./min, 8° C./min, 9° C./min or 10° C./min, with a duration of 1-8 h, optionally including but not limited to 1 h, 2 h, 3 h, 4 h, 5 h, 6 h, 7 h or 8 h.

Optionally, a rotational speed of the rotary steaming is 60-80 revolutions per minute (rpm), optionally including but not limited to 60 rpm, 65 rpm, 70 rpm, 75 rpm or 80 rpm, and more specifically the rotational speed of the rotary steaming is 80 rpm; a heating temperature is 50-60° C., optionally including but not limited to 50° C., 51° C., 52° C., 53° C., 54° C., 58° C., 59° C. or 60° C., and more specifically the heating temperature is 60° C.

Optionally, the filtration and/or centrifugation involves solvent washing, and the solvent includes ethanol.

Optionally, the method of the drying is air atmosphere drying, and the temperature of the drying is 110° C.

Optionally, the method of the activating is air atmosphere activation, and the heating rate is 5° C./min.

Optionally, the inert atmosphere activation includes a combination of one or more of N₂ activation, Ar activation or He activation.

Optionally, the reducing atmosphere activation includes a combination of one or more of H₂ activation, CO activation or NO activation.

The optional and preferred scheme has the beneficial effects that the molecular sieve carrier and the bimetallic ion precursors are dissolved in the solvent, so that the metal ion precursors interact with hydroxyl groups on the surface of the molecular sieve carrier to realize chemical confinement; by using the special cage or pore structure of molecular sieve, the metal ion precursors are confined, so that the metal ions are dispersed into each cage or pore structure of molecular sieve; the single atom breaks the coordination bond between metal ion precursors through the activation step, so that the metal ions coordinate with hydroxyl groups on the surface of the molecular sieve carrier, and the molecular sieve confined single atom is realized.

Optionally, in the in-situ synthesis method:
the ligands include precious metal ligands and transition metal ligands;
the precious metal ligands and the transition metal ligands are excessively added in a preparation process;
a temperature of the hydrothermal reaction is 80-200° C., and a duration is 4-72 h;
a time for the centrifugal washing is more than two times, and solvents of the centrifugal washing are water and ethanol;
a method for the drying is oven drying; and
a temperature of the roasting is 400-600° C., a heating rate is 1° C./min-10° C./min, and a duration is 2-6 h.

Optionally, a molar ratio of precious metal ligands to the precious metal ions is 3:1, and a molar ratio of the transition metal ligands to the transition metal ions is 2:1.

Optionally, the precious metal ligands include ethylenediamine.

Optionally, the transition metal ligands include tetraethylenepentamine.

The optional and preferred schemes have the beneficial effects that in the process of molecular sieve synthesis, an active metal precursor protected by ligand amine is introduced, and the lone pair of the N atom in the ligand amine is transferred to the active metal species to complete the interaction, so that the ligand amine separates the active metal precursor and increases the metal dispersion; as the molecular sieve synthesis solution is alkaline, the ligand amine is capable of preventing precipitation by stabilizing the metal precursor through strong interactions with the active metal, which ultimately leads to the loading of bimetallic ions on the molecular sieve.

Another aspect of the present disclosure provides an application of the single-atom catalyst with molecular sieve-confined domains prepared by the method in catalytic reduction.

Optionally, the application includes using the single-atom catalyst with molecular sieve-confined domains in a catalytic reduction of NO by CO.

Optionally, the catalytic reduction of NO by CO by using the single-atom catalyst with molecular sieve-confined domains also includes O₂.

Optionally, a concentration of the O₂ in the catalytic reduction of NO by CO by using the single-atom catalyst with molecular sieve-confined domains is 0%-5%.

Optionally, a temperature of the catalytic reduction of NO by CO by using the single-atom catalyst with molecular sieve-confined domains is 150-400° C., optionally including but not limited to 150° C., 175° C., 200° C., 225° C., 250° C., 275° C., 300° C., 325° C., 350° C., 375° C. or 400° C.

Optionally, a concentration of the NO in the catalytic reduction of NO by CO by using the single-atom catalyst with molecular sieve-confined domains is 100-600 parts per million (ppm), optionally including but not limited to 100 ppm, 200 ppm, 300 ppm, 400 ppm, 500 ppm or 600 ppm, and more preferably 400 ppm.

Optionally, the application in the catalytic reduction includes an application in stationary source flue gas and/or mobile source tail gas.

Optionally, the stationary source flue gas and/or the mobile source tail gas include NO, CO and O₂.

Optionally, the stationary source flue gas or the mobile source tail gas also includes one or two of SO₂ or H₂O.

Optionally, the single-atom catalyst with molecular sieve-confined domains is used for a selective CO catalytic reduction of NO, where a concentration of NO is 0-400 ppm, optionally including but not limited to 0 ppm, 50 ppm, 100 ppm, 150 ppm, 200 ppm, 250 ppm, 300 ppm, 350 ppm or 400 ppm.

Optionally, the single-atom catalyst with molecular sieve-confined domains is used for the selective CO catalytic reduction of NO, where a concentration of CO is 0-8000 ppm, optionally including but not limited to 0 ppm, 1000 ppm, 2000 ppm, 3000 ppm, 4000 ppm, 5000ppm, 6000 ppm, 7000 ppm or 8000 ppm.

Optionally, the single-atom catalyst with molecular sieve-confined domains is used for the NO catalytic reduction by CO, where the concentration of the O₂ is 0%-5%, optionally including but not limited to 0%, 1%, 2%, 3%, 4% or 5%.

Optionally, the single-atom catalyst with molecular sieve-confined domains is used for the selective CO catalytic reduction of NO, where a SO₂ concentration is 0-20 ppm, optionally including but not limited to 0 ppm, 1 ppm, 2 ppm, 8 ppm, 10 ppm, 12 ppm, 14 ppm, 18 ppm or 20 ppm.

Optionally, the single-atom catalyst with molecular sieve-confined domains is used for the selective CO catalytic reduction of NO, where a concentration of H₂O is 0-10%, optionally including but not limited to 0%, 1%, 2%, 3%, 4%, 5%, 6%, 7%, 8%, 9% or 10%.

Compared with the prior art, the present disclosure has the following advantages and technical effects.

The single-atom catalyst with molecular sieve-confined domains of this disclosure enables the catalyst bimetallic ions to be dispersed as single atoms, so that the oxygen vacancies on the surfaces of the precious metal and the transition metal provide sufficient active sites for the adsorption and dissociation of NO, and the transition metal serves as a sacrificial site for the poisoning of SO₂ to enhance the sulphur-resistant property of the catalyst, and at the same time, promotes the conversion of intermediates, such as N₂O, NO₂ and so forth, to N₂. The efficient adsorption and catalytic reduction of NO by the catalyst is achieved through the synergistic effect of molecular sieves and active components.

The single-atom catalyst with molecular sieve-confined domains provided in the present disclosure makes use of the cage or pore structure of the molecular sieve, thus avoiding the weakening of the NO adsorption capacity of the B acid sites on the surface of the molecular sieve when used as the single-atom anchoring sites, and retaining the surface acidity of the molecular sieve while improving the stability of the single-atom catalyst.

In the single-atom catalyst with molecular sieve-confined domains disclosed by the present disclosure, the ZSM-5 single-atom catalyst with molecular sieve-confined domains with 0.1 wt % Ir and 5 wt % W has a catalytic reduction of NO conversion rate of 98% and N₂ selectivity of 91% at 250° C. under the condition of 3% O₂, suggesting a broad application prospects.

### BRIEF DESCRIPTION OF THE DRAWINGS

The accompanying drawings, which constitute a part of this application, are used to provide a further understanding of this application. The illustrative embodiments of this application and their descriptions are used to explain this application, and do not constitute an improper limitation of this application. In the attached drawings:

FIG. 1 is a schematic structural diagram of a single-atom catalyst with molecular sieve-confined domains prepared in Embodiment 1.

FIG. 2 is a schematic structural diagram of the single-atom catalyst with molecular sieve-confined domains prepared in Embodiment 2.

FIG. 3 is a schematic structural diagram of the single-atom catalyst with molecular sieve-confined domains prepared in Comparative embodiment 1.

FIG. 4 is a schematic structural diagram of the single-atom catalyst with molecular sieve-confined domains prepared in Comparative embodiment 2.

### DETAILED DESCRIPTION OF THE EMBODIMENTS

The following is a clear and complete description of the technical schemes in the embodiments of the present disclosure. Obviously, the described embodiments are only a part of the embodiments of the present disclosure, but not the whole embodiments. Based on the embodiments in the present disclosure, all other embodiments obtained by ordinary technicians in the field without creative labor belong to the scope of protection of the present disclosure.

### Embodiment 1

### Preparation of 0.1% Ir-5% W/ZSM-5 Single-Atom Catalyst With Molecular Sieve-Confined Domains

Chloroiridic acid solution of 0.56 mL (Ir concentration of 10 g/L) and 0.134 g of ammonium metatungstate are taken and added with 100 mL of deionized water and 1.898 g of ZSM-5 molecular sieve carrier, stirred at room temperature for 2 h under the action of magnetic stirrer, and then dried under vacuum on a rotary evaporator at 60° C. and 80 rpm, and dried for 4 h in a blower dryer at 120° C. The solid blocks obtained are ground into powder and placed in a muffle furnace in an air atmosphere of 400° C. for activation for 3 h, with a heating rate of 10° C./min, and cooled to room temperature naturally to obtain the single-atom catalyst with molecular sieve-confined domain, noted as 0.1% Ir-5% W/ZSM-5 catalyst.

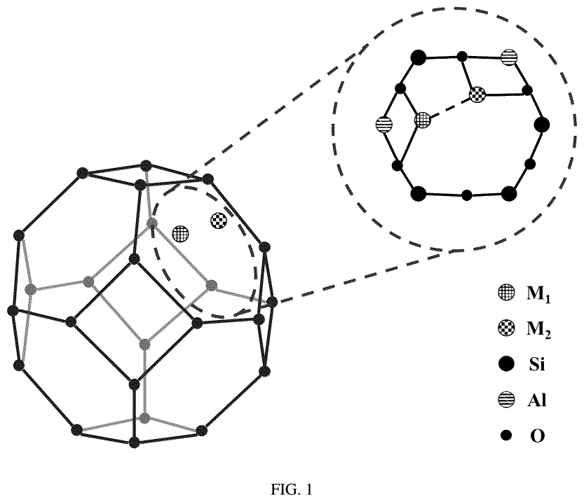

Among them, the structural schematic diagram of 0.1% Ir-5% W/ZSM-5 catalyst is shown in FIG. 1, where the bimetal is located on the surface of molecular sieve.

### Embodiment 2

### Preparation of 0.1% Ir-5% W@ZSM-5 Single-Atom Catalyst With Molecular Sieve-Confined Domains

Compared with Embodiment 1, Ir is introduced in the process of molecular sieve synthesis.

The silicon and aluminum sources are prepared into two aqueous solutions, whereby 0.286 g of NaOH is weighed and added with 20 g of H₂O, and 0.3274 g of NaAlO₂ is added and stirred for 1 h. 0.6 g of NaOH is weighed and added with 16 g of H₂O, and 5.3 g of TPABr is added, and after stirring for 15 min, 20 g of silica sol is added and stirred for 1 h.

The silicon and aluminum sources are mixed, and a mixed solution of 9.6 mL of chloroiridic acid and 10 mL of ethylenediamine ligand is added with a mixed solution of 0.4644 g of ammonium metatungstate and 2.1 mL of tetraethylenepentamine ligand, and co-stirring is carried out for 3 h. The mixed solution is transferred into a 100 mL reactor, and is hydrothermally heated at 170° C. for 32 h.

After centrifugal washing for several times, it is completely dried at 100° C. The dried solid is moved into a muffle furnace and roasted at 550° C. for 6 h at a heating rate of 1° C./min, followed by tabletting and sieving with 40-60 meshes to obtain the single-atom catalyst with molecular sieve-confined domains, which is designated as 0.1% Ir-5% W@ZSM-5 catalyst.

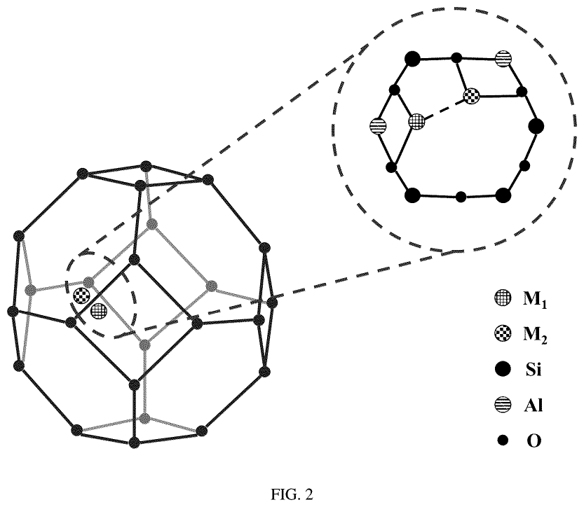

Among them, the structural schematic diagram of the 0.1% Ir-5% W@ZSM-5 catalyst is shown in FIG. 2, and the bimetal is located inside the molecular sieve.

### Comparative Embodiment 1

### Preparation of 0.1% Ir/ZSM-5 Single-Atom Catalyst With Molecular Sieve-Confined Domains

Chloroiridic acid solution (Ir concentration of 10 g/L) of 0.56 mL is taken, and 100 mL of deionized water and 1.998 g of ZSM-5 molecular sieve carrier are added, stirred for 2 h at room temperature under the action of magnetic stirrer, and then dried under vacuum on a rotary evaporator at 60° C. and 80 rpm, and dried for 4 h in a blower dryer at 120° C. The solid blocks obtained are ground into powder and placed in a muffle furnace in an air atmosphere of 400° C. for activation for 3 h, with a heating rate of 10° C./min, and cooled to room temperature naturally to obtain the single-atom catalyst with molecular sieve-confined domain, noted as 0.1% Ir/ZSM-5 catalyst.

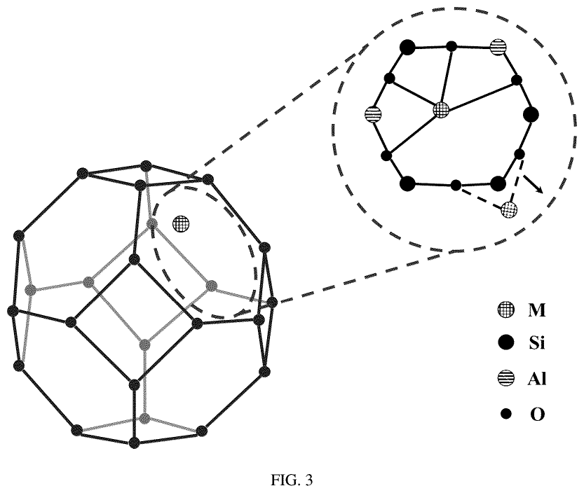

Among them, the structural schematic diagram of the 0.1% Ir@ZSM-5 catalyst is shown in FIG. 3, and the single metal is located on the surface of molecular sieve.

### Comparative Embodiment 2

### Preparation of 0.1% Ir@ZSM-5 Single-Atom Catalyst With Molecular Sieve-Confined Domains

Compared with Comparative embodiment 1, Ir is introduced during the synthesis of molecular sieve.

The silicon and aluminum sources are prepared into two aqueous solutions, whereby 0.286 g of NaOH is weighed and added with 20 g of H₂O, and 0.3274 g of NaAlO₂ is added and stirred for 1 h. 0.6 g of NaOH is weighed and added with 16 g of H₂O, and 5.3 g of TPABr is added, and after stirring for 15 min, 20 g of silica sol is added and stirred for 1 h.

The silicon and aluminum sources are mixed, and a mixed solution of 8.6 mL of chloroiridic acid and 10 mL of ethylenediamine ligand is added with a mixed solution of 0.4644 g of ammonium metatungstate and 2.1 mL of tetraethylenepentamine ligand, and co-stirring is carried out for 3 h. The mixed solution is transferred into a 100 mL reactor, and is hydrothermally heated at 170° C. for 32 h.

After centrifugal washing for many times, it is completely dried at 100° C. The dried solid is moved into a muffle furnace and roasted at 550° C. for 6 h at a heating rate of 1° C./min, followed by tabletting and sieving with 40-60 meshes to obtain the single-atom catalyst with molecular sieve-confined domains, which is designated as 0.1% Ir@ZSM-5 catalyst.

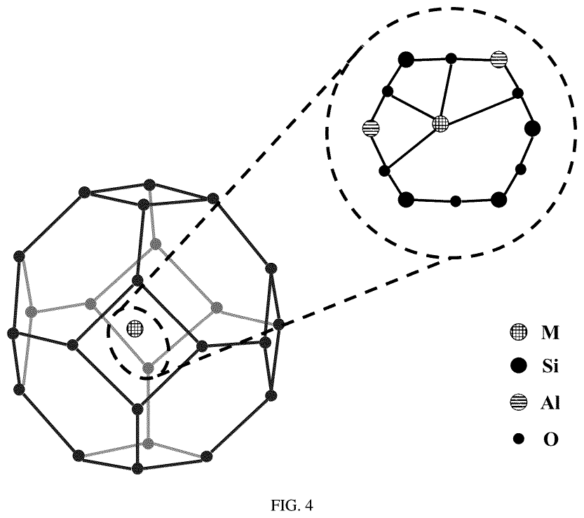

Among them, the structural schematic diagram of 0.1% Ir@ZSM-5 catalyst is shown in FIG. 4, and the single metal is located inside the molecular sieve.

### Comparative Embodiment 3

Compared with Comparative embodiment 1, the catalyst carrier is changed to Al₂O₃, and other conditions are completely the same as those of Comparative embodiment 1 to obtain the single-atom catalyst with molecular sieve-confined domains, recorded as 0.1% Ir/Al₂O₃.

FIG. 1 and FIG. 3 schematically show that the single-metal/bimetal is located on the surface of molecular sieve in the catalyst synthesized by post-processing; while FIG. 2 and FIG. 4 schematically show that the single-metal/bimetal of the catalyst synthesized by in-situ synthesis is located inside the molecular sieve.

### Performance Test

### Activity Test of Catalytic Reduction of NO by CO

The catalysts prepared in Embodiments 1-2 and Comparative embodiments 1-3 are tested for catalytic reduction of NO by CO, and the test method is as follows.

The composition of the simulated flue gas is as follows: the volume concentration of NO is 400 ppm, the volume concentration of CO is 8000 ppm, the volume fraction of O₂ is 3%, the volume concentration of SO₂ is 20 ppm, N₂ is the equilibrium gas, the catalyst loading in the fixed bed reactor is 0.2 g, the airspeed in the test process is GHSV≈16,000 h⁻¹, and the test temperatures are 225° C., 250° C. and 275° C. respectively, and each temperature is held for 1 h; the above test results are shown in Table 1, and the calculation methods of NO conversion rate (X_{NO}) and N₂ selectivity (S_{N2}) are shown in formulas 1-1 and 1-2.

$${X}_{NO} = [ 1 - \frac{NO ( out )}{NO ( in )} ] \times 100 \% \qquad ( 1 - 1 )$$

$${S}_{{N}_{2}} = \frac{[ NO ( in ) - NO ( out ) ] - 2 \times {N}_{2} O ( out ) - {NO}_{2} ( out )}{NO ( in ) - NO ( out )} \times 100 \% \qquad ( 1 - 2 )$$

In the formulas, in represents the inflow and out represents the discharge.

TABLE 1

| | | Embodiment | Embodiment | Comparative | Comparative | Comparative |
|---|---|---|---|---|---|---|
| | | 1 | 2 | embodiment 1 | embodiment 2 | embodiment 3 |
| 225° C. | NO | 68.3 | 64.8 | 48.9 | 43.8 | 1.5 |
| | conversion | | | | | |
| | rate (%) | | | | | |
| | N₂ | 62.4 | 61.2 | 61.7 | 56.5 | 4.6 |
| | selectivity | | | | | |
| | (%) | | | | | |
| 250° C. | NO | 98.3 | 93.4 | 92.8 | 90.5 | 91.3 |
| | conversion | | | | | |
| | rate (%) | | | | | |
| | N₂ | 96.1 | 91.2 | 80.6 | 73.3 | 10.1 |
| | selectivity | | | | | |
| | (%) | | | | | |
| 275° C. | NO | 99.8 | 95.9 | 94.4 | 92.4 | 12.4 |
| | conversion | | | | | |
| | rate (%) | | | | | |
| | N₂ | 98.4 | 96.7 | 96.7 | 95.2 | 12.3 |
| | selectivity | | | | | |
| | (%) | | | | | |
| 300° C. | NO | 98.8 | 96.5 | 95.6 | 93.9 | 12.4 |
| | conversion | | | | | |
| | rate (%) | | | | | |
| | N₂ | 97.1 | 95.3 | 93.4 | 92.5 | 12.3 |
| | selectivity | | | | | |
| | (%) | | | | | |

### Stability Test of Catalytic Reduction of NO by CO

The catalysts prepared in Embodiments 1-2 and Comparative embodiments 1-3 are tested for catalytic reduction of NO by CO, and the test method is as follows.

The composition of simulated flue gas is as follows: the volume concentration of NO is 400 ppm, the volume concentration of CO is 8000 ppm, the volume fraction of O₂ is 3%, the volume concentration of SO₂ is 20 ppm, N₂ is the equilibrium gas, the catalyst loading in the fixed bed reactor is 0.2 g, the airspeed in the test process is GHSV≈16,000 h⁻¹, and the test temperature is 250° C. The above test results are shown in Table 1. The calculation methods of NO conversion (X_{NO}) and N₂ selectivity (S_{N2}) are the same as those in the formulas 1-1 and 1-2.

TABLE 2

| | | Embodiment | Embodiment | Comparative | Comparative | Comparative |
|---|---|---|---|---|---|---|
| | | 1 | 2 | embodiment 1 | embodiment 2 | embodiment 3 |
| 6 h | NO | 95.7 | 94.7 | 92.6 | 91.2 | 12.3 |
| | conversion | | | | | |
| | rate (%) | | | | | |
| | N₂ selectivity | 98.8 | 95.6 | 80.1 | 94.3 | 11.2 |
| | (%) | | | | | |
| 12 | NO | 95.3 | 94.5 | 92.5 | 90.9 | 10.3 |
| h | conversion | | | | | |
| | rate (%) | | | | | |
| | N₂ selectivity | 97.9 | 95.2 | 79.8 | 93.8 | 10.6 |
| | (%) | | | | | |
| 18 | NO | 80.3 | 93.9 | 71.5 | 90.1 | 9.5 |
| h | conversion | | | | | |
| | rate (%) | | | | | |
| | N₂ selectivity | 85.6 | 95.3 | 65.2 | 91.5 | 8.4 |
| | (%) | | | | | |
| 24 | NO | 76.8 | 94.0 | 70.3 | 90.2 | 8.2 |
| h | conversion | | | | | |
| | rate (%) | | | | | |
| | N₂ selectivity | 81.0 | 95.1 | 63.1 | 89.9 | 6.5 |
| | (%) | | | | | |

### Experimental Results:

It can be seen from Table 1 that the single-atom catalyst with molecular sieve-confined domains prepared by the present disclosure is capable of significantly improving the NO conversion rate and N₂ selectivity, with the NO conversion rate as high as 99.8% and N₂ selectivity as high as 98.4%, indicating that the single-atom catalyst with molecular sieve-confined domains provided by the present disclosure has excellent catalytic activity and may significantly improve the ideal product selectivity of the catalyst.

From Table 2, it is observed that the single-atom catalyst with molecular sieve-confined domains provided by the present disclosure is capable of significantly improving the stability of the catalyst, enabling a maintenance of more than 94% NO conversion rate and more than 94% N₂ selectivity within 24 hours of reaction, indicating that the single-atom catalyst with molecular sieve-confined domains provided by the present disclosure has excellent catalytic stability and may significantly improve the service life of the catalyst.

By comparing the data of Embodiment 1 and Embodiment 2 in the Table 1, the catalytic activity of the single-atom catalyst with molecular sieve-confined domains prepared by the post-processing method (Embodiment 1) is higher than that of the single-atom catalyst with molecular sieve-confined domains prepared by the in-situ synthesis method (Embodiment 2).

The stability of the single-atom catalyst with molecular sieve-confined domains prepared by the in-situ synthesis method (Embodiment 2) is higher than that of the single-atom catalyst with molecular sieve-confined domains prepared by the post-processing method (Embodiment 1), as may be seen from the comparison of the data of Embodiment 1 and Embodiment 2 in Table 2.

The above describes only the preferred embodiments of this application, but the protection scope of this application is not limited to this. Any change or replacement that may be easily thought of by a person familiar with this technical field within the technical scope disclosed in this application should be included in the protection scope of this application. Therefore, the protection scope of this application should be based on the protection scope of the claims.

What is claimed is:

1. A single-atom catalyst with molecular sieve-confined domains, wherein the single-atom catalyst takes a molecular sieve as a carrier and bimetallic ions as active components, and the bimetallic ions are confined in the physical structure of the molecular sieve by utilizing a physical structure and a chemical anchoring action of the molecular sieve.

2. The single-atom catalyst with molecular sieve-confined domains according to claim 1, wherein the physical structure of the molecular sieve comprises a cage or a pore structure; the chemical anchoring action is carried out by using aluminum-rich sites of molecular sieves.

3. The single-atom catalyst with molecular sieve-confined domains according to claim 1, wherein the bimetallic ions are a combination of precious metal ions and transition metal ions.

4. The single-atom catalyst with molecular sieve-confined domains according to claim 3, wherein an electronegativity of the precious metal ions is greater than an electronegativity of the transition metal ions.

5. The single-atom catalyst with molecular sieve-confined domains according to claim 3, wherein a loading of the precious metal ions in the single-atom catalyst is 0.1%-1%, and a loading of the transition metal ions in the single-atom catalyst is 0.1%-10%.

6. A preparation method of the single-atom catalyst with molecular sieve-confined domains according to claim 1, wherein the preparation method comprises a post-processing method or an in-situ synthesis method;
the post-processing method comprises:
mixing precursors of the molecular sieve and the bimetallic ions with a solvent for a reaction, carrying out solid-liquid separation on a reaction product, collecting and drying a solid, and activating the solid after drying to obtain the single-atom catalyst with molecular sieve-confined domains; and
the in-situ synthesis method comprises:
mixing a template agent, a silicon source, an aluminum source, alkali and water according to a molar ratio of a general formula of a molecular sieve, simultaneously adding precursors of the bimetallic ions and ligands, and heating in a hydrothermal kettle for a hydrothermal reaction, performing centrifugal washing and drying on precipitated molecular sieve crystals loaded with bimetallic metals, and then roasting to obtain the single-atom catalyst with molecular sieve-confined domains.

7. The preparation method according to claim 6, wherein in the post-processing method and the in-situ synthesis method:
the general formula of the molecular sieve is (M′2M)O·Al₂O₃·xSiO₂·yH₂O; in the general formula of the molecular sieve, x is a ratio of silicon to aluminum, with a value of 2-500; and a value of y in the general formula of the molecular sieve is 50-250; and
the precursors of the bimetallic ions comprise precursors of precious metal ions and precursors of transition metal ions; the precursors of the precious metal ions comprise iridium acetate and/or chloroiridium acid, silver nitrate and/or silver chloride, chloroplatinic acid and/or platinum tetraamine dinitrate, rhodium acetate and/or rhodium trichloride, palladium nitrate and/or chloroplatinic acid, ruthenium acetate and/or ruthenium chloride, gold acetate and/or chloroauric acid; and the precursors of the transition metal ions comprise ammonium metatungstate and/or ammonium tungstate, ammonium molybdate, cerium nitrate, cobalt nitrate, manganese nitrate and copper nitrate.

8. The preparation method according to claim 6, wherein in the post-processing method:
the solvent is water, a temperature of the reaction is 25-100 degrees Celsius, a duration is 2-6 hours, a pH value is 6-8; a method of the solid-liquid separation comprise filtration, rotary steaming and/or centrifugation; a method of the drying comprises one or a combination of vacuum drying or air atmosphere drying; a temperature of the drying is 100-120 degrees Celsius; a method of the activating includes any one or a combination of at least two of vacuum activation, air atmosphere activation, inert atmosphere activation or reducing atmosphere activation; a temperature of the activating is 350-600 degrees Celsius, a heating rate is 2-10 degrees Celsius per minutes, with a duration of 1-8 hours.

9. The preparation method according to claim 6, wherein the template agent comprises one of tetramethylammonium hydroxide, tetrapropylammonium hydroxide, tetrapropylammonium bromide, tetraethylammonium bromide and cetyltrimethylammonium bromide; the silicon source comprises one of water glass, silica sol, silica gel, amorphous SiO₂ powder and Si(OCH₃)₄, Si(OC₂H₅)₄; the aluminum source comprises one of sodium metaaluminate, boehmite, pseudo-boehmite, amorphous aluminum hydroxide powder and aluminum isopropoxide; the alkali comprises one of sodium hydroxide and potassium hydroxide;
the ligands comprise precious metal ligands and transition metal ligands; the precious metal ligand comprises ethylenediamine; the transition metal ligand comprises tetraethylenepentamine;
a temperature of the hydrothermal reaction is 80-200 degrees Celsius, with a duration of 4-72 hours; a time of the centrifugal washing is more than two times, solvents of the centrifugal washing are water and ethanol; a method for the drying is oven drying; a temperature of the roasting 400-600 degrees Celsius, with a heating rate of 1 degrees Celsius per minutes-10 degrees Celsius per minutes and a duration of 2-6 hours.

10. An application of the single-atom catalyst with molecular sieve-confined domains according to claim 1 in catalytic reduction.
